(19) United States
(12) Patent Application Publication
(10) Pub. No.: US 2023/0368072 A1
(43) Pub. Date: Nov. 16, 2023

(54) COMPUTER-READABLE RECORDING MEDIUM STORING MACHINE LEARNING PROGRAM, MACHINE LEARNING METHOD, AND INFORMATION PROCESSING DEVICE

(71) Applicant: Fujitsu Limited, Kawasaki-shi, Kanagawa (JP)

(72) Inventor: Akinori IWAKAWA, Kawasaki (JP)

(73) Assignee: Fujitsu Limited, Kawasaki-shi, Kanagawa (JP)

(21) Appl. No.: 18/113,061

(22) Filed: Feb. 23, 2023

(30) Foreign Application Priority Data
May 13, 2022 (JP) 2022-079842

(51) Int. Cl. G06N 20/00

(52) U.S. Cl. CPC G06N 20/00

(57) ABSTRACT

A non-transitory computer-readable recording medium storing a machine learning program for causing a computer to execute a process, the process includes determining a similar range for second training data in a case where a determination label inferred by inputting the second training data to a classifier machine-learned by using a first training data group that includes a plurality of first training data, and a ground truth of the second training data are different, creating a second training data group by removing at least the first training data included in the similar range from the plurality of first training data, and newly performing machine learning of the classifier using the second training data group.

### CROSS-REFERENCE TO RELATED APPLICATION

This application is based upon and claims the benefit of priority of the prior Japanese Patent Application No. 2022-079842, filed on May 13, 2022, the entire contents of which are incorporated herein by reference.

### FIELD

The embodiments discussed herein are related to a machine learning program, a machine learning method, and an information processing device.

### BACKGROUND

In recent years, data classification techniques by machine learning have been developed. In an example, a document classification system is known. The document classification system classifies documents into a plurality of fields (classes) according to content by applying natural language processing by machine learning.

During training of a classifier (model) in supervised training, supervised data is created in which target data and a ground truth indicating a class to which the target data belongs are paired. The classifier is trained using the supervised data as training data. During inference, the classifier calculates a probability that data belongs to each class when the data to be determined is input. The classifier may output the class with the highest probability that the data belongs to the class as a determination label.

There are some cases where the training data becomes obsolete due to changes in the ground truth for the target data due to changes in current affairs or the like. In an example, in a case of classifying a sentence related to “virus mutation”, there are some cases where the ground truth is “science” during creation of existing training data, but the ground truth is “society” during creation of subsequent new training data.

However, recreating all the existing training data into new training data in accordance with the changes in current affairs or the like increases a burden on an operator. Therefore, in the past, retraining has been performed by sequentially adding new training data to the existing training data.

Japanese Laid-open Patent Publication No. 2020-160543 is disclosed as related art.

### SUMMARY

According to an aspect of the embodiments, a non-transitory computer-readable recording medium storing a machine learning program for causing a computer to execute a process, the process includes determining a similar range for second training data in a case where a determination label inferred by inputting the second training data to a classifier machine-learned by using a first training data group that includes a plurality of first training data, and a ground truth of the second training data are different, creating a second training data group by removing at least the first training data included in the similar range from the plurality of first training data, and newly performing machine learning of the classifier using the second training data group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a hardware configuration of an information processing device according to a first embodiment;

FIG. 2 is a diagram illustrating a functional configuration of the information processing device according to the first embodiment;

FIG. 3 is a diagram illustrating an example of a classifier;

FIG. 4 is a block diagram schematically illustrating a software configuration example during training in the first embodiment;

FIG. 5 is a table illustrating an example of a first training data group;

FIG. 6 is a block diagram schematically illustrating a software configuration example during inference in the first embodiment;

FIG. 7 is a diagram illustrating an example of update processing for an existing training data group in a comparative example;

FIG. 8 is a diagram illustrating an example of update processing for an existing training data group in the first embodiment;

FIG. 9 is a diagram illustrating an example of selection processing for second training data in the first embodiment;

FIG. 10 is a diagram illustrating an example of classification processing in a comparative example;

FIG. 11 is a diagram illustrating an example of classification processing in the first embodiment;

FIG. 12 is a table illustrating an example of a first table illustrating cosine similarity between different data and equivalent data;

FIG. 13 is a table illustrating an example of a second table illustrating cosine similarity between different data and the first training data group;

FIG. 14 is a block diagram schematically illustrating a software configuration example during training after updating training data in the first embodiment;

FIG. 15 is a flowchart illustrating processing during training by the information processing device in the first embodiment;

FIG. 16 is a flowchart illustrating training data generation processing of the information processing device in the first embodiment;

FIG. 17 is a flowchart illustrating selection processing for the second training data by the information processing device in the first embodiment;

FIG. 18 is a flowchart illustrating update processing for existing training data by the information processing device in the first embodiment;

FIG. 19 is a flowchart illustrating processing during retraining by the information processing device in the first embodiment;

FIG. 20 is a block diagram schematically illustrating a software configuration example during inference in a second embodiment;

FIG. 21 is a flowchart illustrating update processing for existing training data by an information processing device in the second embodiment;

FIG. 22 is a block diagram schematically illustrating a software configuration example during inference in a third embodiment;

FIG. 23 is a table illustrating an example of index data;

FIG. 24 is a diagram illustrating an example of data selection processing based on the index data;

FIG. 25 is a diagram illustrating another example of the data selection processing based on the index data;

FIG. 26 is a block diagram schematically illustrating a software configuration example during creation of new second training data in the third embodiment;

FIG. 27 is a table illustrating an example of unlabeled new training data candidates;

FIG. 28 is a table illustrating an example of a third table illustrating cosine similarity between index data and the unlabeled new training data candidates;

FIG. 29 is a table illustrating an example of ground-truth-labeled data;

FIG. 30 is a diagram illustrating an example of selection processing for labeling-waiting data in the third embodiment;

FIG. 31 is a flowchart illustrating selection processing for second training data by an information processing device in the third embodiment;

FIG. 32 is a flowchart illustrating an example of update processing for existing training data by the information processing device in the third embodiment; and

FIG. 33 is a flowchart illustrating another example of the update processing for existing training data by the information processing device in the third embodiment.

### DESCRIPTION OF EMBODIMENTS

According to the method of performing retraining by adding new supervised data to existing supervised data, there is a possibility that the obsolete existing supervised data temporarily remains. The presence of the existing supervised data similar to new supervised data, and the existing supervised data and the new supervised data having different ground truths causes a decrease in classification accuracy. Therefore, if obsolete training data remains, it may be difficult to suppress the decrease in the classification accuracy.

Hereinafter, embodiments of techniques capable to suppress a decrease in data classification accuracy due to obsolescence of training data will be described with reference to the drawings. Note that the embodiments to be described below are merely examples, and there is no intention to exclude application of various modifications and techniques not explicitly described in the embodiments. For example, the present embodiments may be variously modified and performed without departing from the gist thereof. Furthermore, each drawing is not intended to include only configuration elements illustrated in the drawings, and may include another function and the like.

### First Embodiment

### [A Configuration

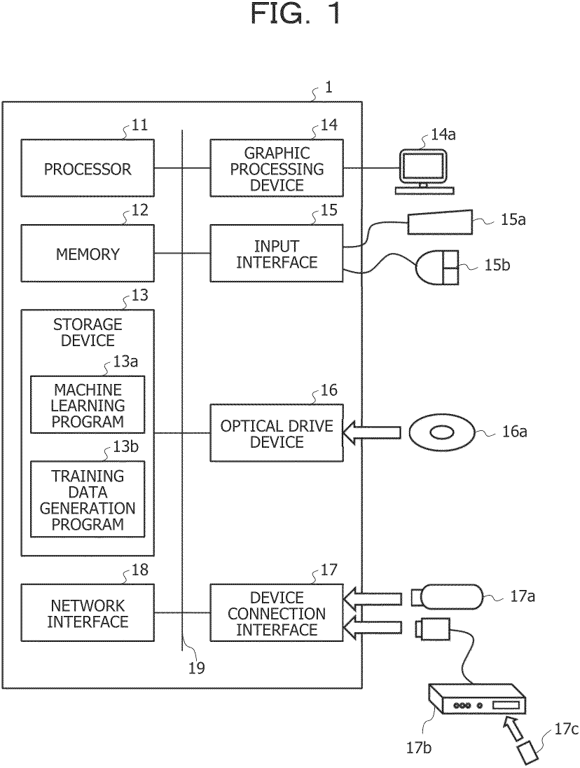

FIG. 1 is a diagram illustrating a hardware configuration of an information processing device 1 as an example of an embodiment.

As illustrated in FIG. 1, the information processing device 1 includes, for example, a processor 11, a memory 12, a storage device 13, a graphic processing device 14, an input interface 15, an optical drive device 16, a device connection interface 17, and a network interface 18, as configuration elements. These configuration elements 11 to 18 are configured to be communicable with each other via a bus 19. The information processing device 1 is an example of a computer.

The processor 11 controls the entire information processing device 1. The processor 11 is an example of a control unit. The processor 11 may be a multiprocessor. The processor 11 may be, for example, any one of a central processing unit (CPU), a micro processing unit (MPU), a digital signal processor (DSP), an application specific integrated circuit (ASIC), a programmable logic device (PLD), a field programmable gate array (FPGA), and a graphics processing unit (GPU). Furthermore, the processor 11 may be a combination of two or more types of elements of the CPU, MPU, DSP, ASIC, PLD, FPGA, and GPU.

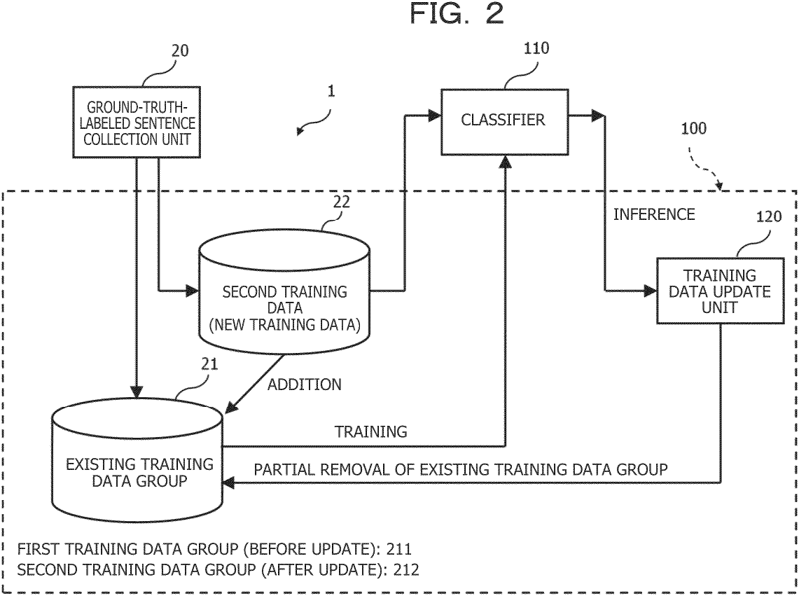

The processor 11 executes a control program (machine learning program 13a or training data generation program 13b) to implement a function of a training processing unit 100 illustrated in FIG. 2. The training data generation program 13b may be provided as part of the machine learning program 13a.

The information processing device 1 executes the machine learning program 13a, the training data generation program 13b, and an operating system (OS) program that are programs recorded in a computer-readable non-transitory recording medium, for example, to implement the function as the training processing unit 100.

The program in which processing content to be executed by the information processing device 1 is described may be recorded in various recording media. For example, the machine learning program 13a or the training data generation program 13b to be executed by the information processing device 1 can be stored in the storage device 13. The processor 11 loads at least part of the machine learning program 13a or the training data generation program 13b in the storage device 13 into the memory 12 and executes the loaded program.

Furthermore, the machine learning program 13a or the training data generation program 13b to be executed by the information processing device 1 (processor 11) can also be recorded in a non-temporary portable recording medium such as an optical disc 16a, a memory device 17a, or a memory card 17c. The program stored in the portable recording medium becomes executable after being installed in the storage device 13 under the control of the processor 11, for example. Furthermore, the processor 11 can also read and execute the machine learning program 13a or the training data generation program 13b directly from the portable recording medium.

The memory 12 is a storage memory including a read only memory (ROM) and a random access memory (RAM). The RAM of the memory 12 is used as a main storage device of the information processing device 1. The RAM temporarily stores at least a part of the OS program and the control program to be executed by the processor 11. Furthermore, the memory 12 stores various types of data needed for processing by the processor 11.

The storage device 13 is a storage device such as a hard disk drive (HDD), a solid state drive (SSD), or a storage class memory (SCM), and stores various types of data. The storage device 13 is used as an auxiliary storage device of the information processing device 1. The storage device 13 stores the OS program, the control program, and various types of data. The control program includes the machine learning program 13a or the training data generation program 13b.

A semiconductor storage device such as an SCM or a flash memory may be used as the auxiliary storage device. Furthermore, redundant arrays of inexpensive disks (RAID) may be configured using a plurality of the storage devices 13.

Furthermore, the storage device 13 may store various types of training data (supervised data) to be described below and various types of data generated when each processing is executed.

The graphic processing device 14 is connected to a monitor 14a. The graphic processing device 14 displays an image on a screen of the monitor 14a in accordance with an instruction from the processor 11. Examples of the monitor 14a include a display device using a cathode ray tube (CRT), a liquid crystal display device, and the like.

The input interface 15 is connected to a keyboard 15a and a mouse 15b. The input interface 15 transmits signals sent from the keyboard 15a and the mouse 15b to the processor 11. Note that the mouse 15b is an example of a pointing device, and another pointing device may be used. Examples of the another pointing device include a touch panel, a tablet, a touch pad, a track ball, and the like.

The optical drive device 16 reads data recorded in the optical disc 16a by using laser light or the like. The optical disc 16a is a non-transitory portable recording medium having data recorded in a readable manner by reflection of light. Examples of the optical disc 16a include a digital versatile disc (DVD), a DVD-RAM, a compact disc read only memory (CD-ROM), a CD-recordable (R)/rewritable (RW), and the like.

The device connection interface 17 is a communication interface for connecting a peripheral device to the information processing device 1. For example, the device connection interface 17 may be connected to the memory device 17a or a memory reader/writer 17b. The memory device 17a is a non-transitory recording medium equipped with a communication function with the device connection interface 17, for example, a universal serial bus (USB) memory. The memory reader/writer 17b writes data to the memory card 17c or reads data from the memory card 17c. The memory card 17c is a card-type non-transitory recording medium.

The network interface 18 is connected to a network (not illustrated). The network interface 18 may be connected to another information processing device, a communication device, and the like via the network. For example, data such as an input sentence may be input via the network.

FIG. 2 is a diagram exemplarily illustrating a functional configuration of the information processing device 1 according to the first embodiment. The information processing device 1 has the function as the training processing unit 100, as illustrated in FIG. 2. In the information processing device 1, the processor 11 executes the control program (machine learning program 13a or training data generation program 13b) to implement the function of the training processing unit 100.

The training processing unit 100 implements training processing (training) in machine learning using the training data. For example, the information processing device 1 functions as a training device that trains a machine learning model of a classifier 110 by the training processing unit 100.

The training processing unit 100 includes a training data update unit 120.

A ground-truth-labeled sentence collection unit 20 is a device that acquires training data to be used for training the classifier 110. The training data may be supervised data in which target data and a ground truth indicating classification (class) to which the target data belongs are paired.

In the present example, the training data includes an existing training data group 21. The classifier 110 is machine-learned using the existing training data group 21. Second training data 22 is added to the existing training data group 21 in order to suppress obsolescence of the existing training data group 21 due to changes in current affairs or the like. The second training data 22 is new training data added to the existing training data group 21.

The training data update unit 120 updates the existing training data group 21 by deleting some data of the existing training data group 21. The training data update unit 120 adds the second training data 22 to the existing training data group 21.

The existing training data group 21 before addition of the second training data 22 and before update is referred to as a “first training data group 211”. The existing training data group 21 after addition of the second training data 22 and after update is referred to as a “second training data group 212”. The second training data group 212 includes the added second training data 22.

During inference, the classifier 110 classifies the input data into a plurality of classes according to the content. The training processing unit 100 implements the training (machine learning) of the classifier 110 during training.

The classifier 110 may be a document classifier that classifies input sentence data into a plurality of fields according to the content.

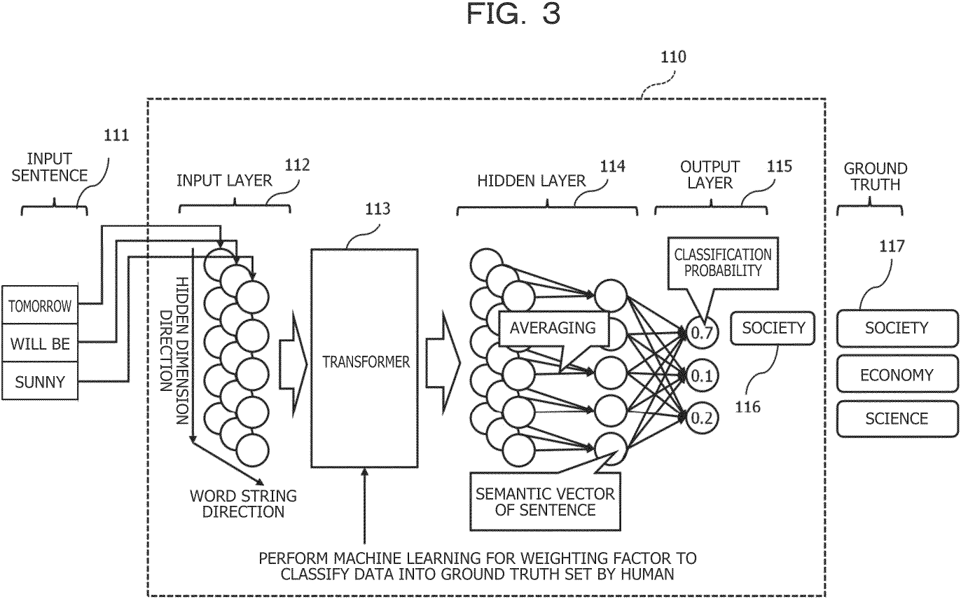

FIG. 3 is a diagram illustrating an example of the classifier 110. The classifier 110 is a machine learning model for classifying the input data into a plurality of classes. The machine learning model may be, for example, a deep learning model (deep neural network). The neural network may be a hardware circuit, or may be a virtual network by software that connects between layers virtually constructed on a computer program by the processor 11 or the like.

In FIG. 3, input data is input to the classifier 110. Description will be given taking a case where the input data is an input sentence 111 as an example. The input sentence 111 includes a plurality of words (in FIG. 3, words “tomorrow”, “will be”, and “sunny”). Each of the words may be represented by a fixed-length semantic vector. Representing words with semantic vectors is called “distributed representation of words”. A method of obtaining the distributed representations of words is similar to existing methods. The content of the input data is not limited to those illustrated in FIG. 3.

The classifier 110 of FIG. 3 includes an input layer 112, a transformer 113, a hidden layer 114, and an output layer 115.

The input layer 112 is given by an n x m matrix corresponding to the number n of dimensions (hidden dimensions) of the hidden layer 114 and the number m of word strings (word string direction). The transformer 113 machine-learns weighting factors so as to classify data into a set ground truth 117. The hidden layer 114 outputs a semantic vector of the input data. A semantic vector is an example of a feature map vector.

The output layer 115 calculates a probability that the input data belongs to each classification (class). In the example of FIG. 3, classification probabilities that the input sentence 111 belongs to fields of society, economy, and science are 0.7, 0.1, and 0.2. The output layer 115 may output the field with the highest probability as a determination label 116.

Note that the configuration of the classifier 110 is not limited to that in FIG. 3. Various classifiers 110 may be used as long as the classifiers classify the input data into a plurality of classes according to the content of the input data. In the case where the classifier 110 is a document classifier, various natural language processing methods such as recurrent neural network (RNN), long short term memory (LSTM), Seq2Seq model, Seq2Seq model with Attention, and Transformer may be used.

### [A1] During Training

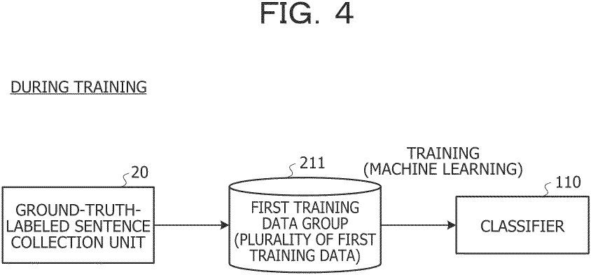

FIG. 4 is a block diagram schematically illustrating a software configuration example during training in the first embodiment. During training, the ground-truth-labeled sentence collection unit 20 collects the existing training data group 21 (first training data group 211) including the input sentence 111 and the ground truth 117 for the input sentence 111. The classifier 110 is trained using the first training data group 211. The first training data group 211 includes a plurality of first training data. The first training data is an example of first training data.

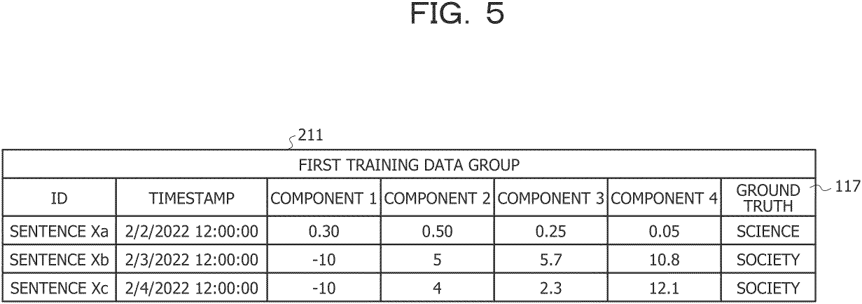

FIG. 5 is a table illustrating an example of the first training data group 211. The first training data group 211 may include identification information ID that identifies the input sentence 111, a timestamp, components of the semantic vector of the input sentence 111, and the ground truth 117.

The classifier 110 performs machine learning by adjusting the weighting factors of the transformer 113, the hidden layer 114, and the like such that an error between the determination label 116 by the classifier 110 and the ground truth 117 added to the first training data group 211 becomes small.

### [A2] During Inference (During Generation of the Second Training Data Group 212)

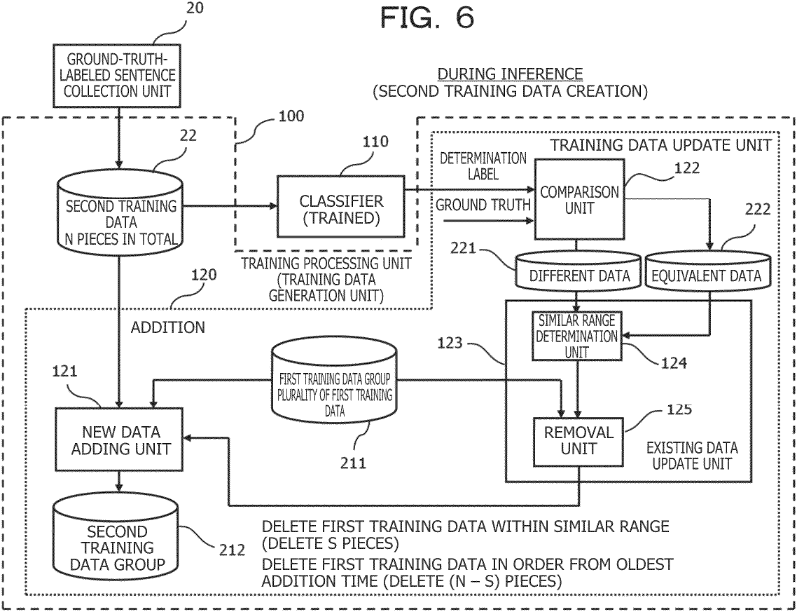

FIG. 6 is a block diagram schematically illustrating a software configuration example during inference (during generation of the second training data group 212) in the first embodiment. The classifier 110 has already been machine-learned using the existing training data such as the first training data group 211, as illustrated in FIG. 4.

The training data update unit 120 may include a new data adding unit 121, a comparison unit 122, and an existing data update unit 123.

The new data adding unit 121 adds the second training data 22 as the new training data to the existing training data group 21 such as the first training data group 211. As a result, the existing training data group 21 is updated from the first training data group 211 to the second training data group 212. The number of second training data 22 to be added is N and may be predetermined. By adding the second training data 22, the new data adding unit 121 prevents obsolescence of the existing training data group 21 due to changes in current affairs or the like.

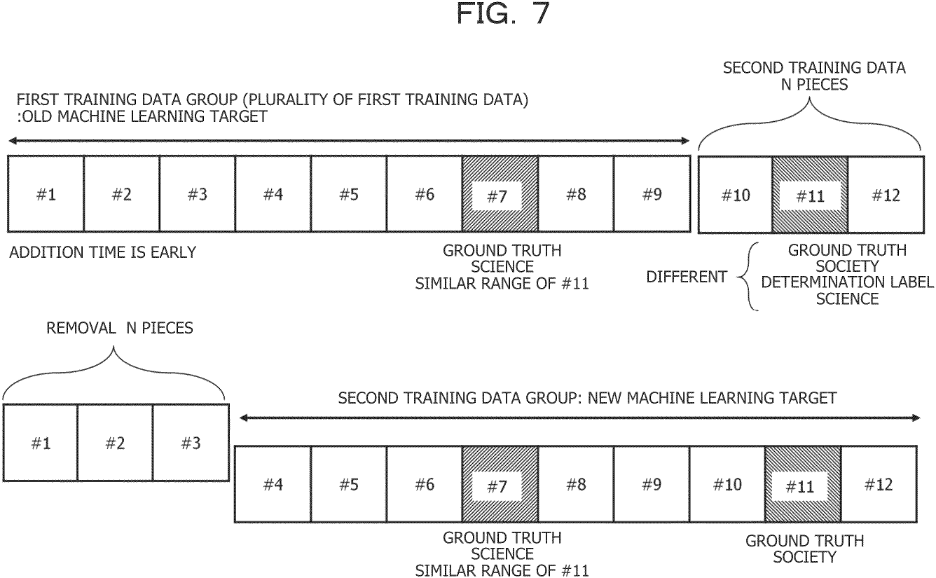

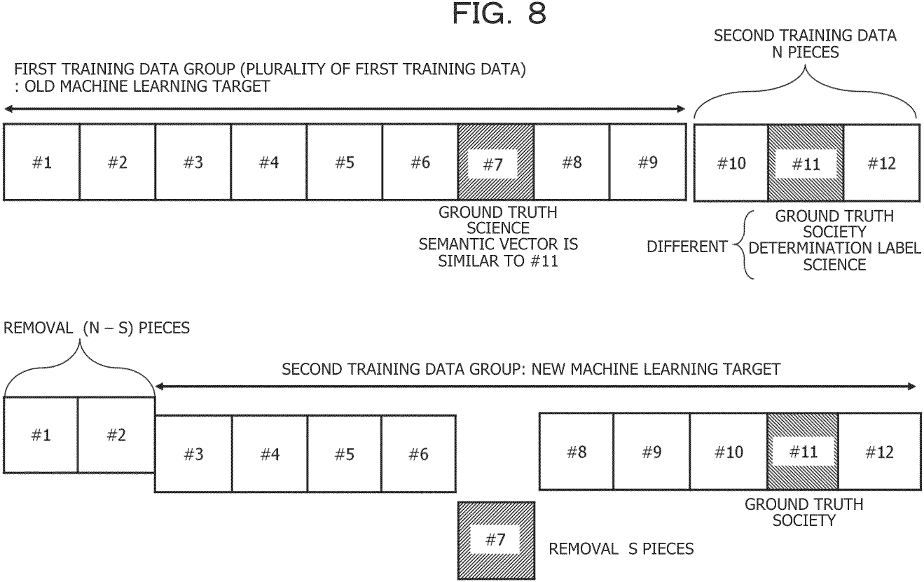

FIG. 7 is a diagram illustrating an example of update processing for the existing training data group 21 in a comparative example. FIG. 8 is a diagram illustrating an example of update processing for the existing training data group 21 in the first embodiment. In FIGS. 7 and 8, the first training data group 211, which is the existing training data group 21 registered at an earlier time than the second training data 22, includes a plurality of first training data #1 to #9. The new data adding unit 121 newly adds a total of N pieces of second training data 22 (N = 3 in FIGS. 7 and 8), which are #10, #11, and #12. In FIGS. 7 and 8, registration time of data is earlier, for example, older, toward the left.

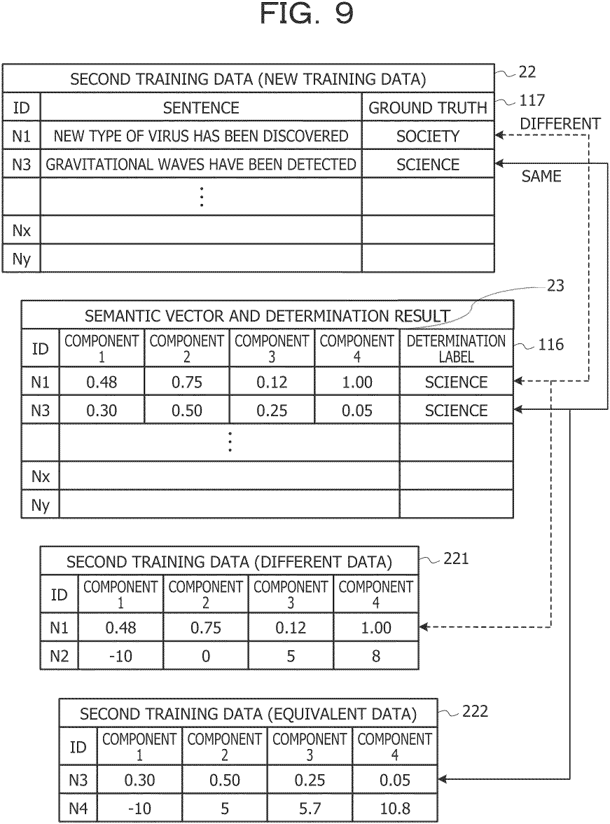

FIG. 9 is a diagram illustrating an example of selection processing for the second training data 22 in the first embodiment.

The second training data 22 (#10, #11, and #12 in FIG. 8) to be added are input to the classifier 110 that has been machine-learned using the first training data group 211. The classifier 110 infers the determination label 116 for the second training data 22. The second training data 22 may include the ID, the input sentence 111, and the ground truth 117, as illustrated in FIG. 9. In FIG. 9, N1 is the input sentence 111 “A new type of virus has been discovered”, and the ground truth 117 of N1 is “society”. N3 is the input sentence 111 “gravitational waves have been detected”, and the ground truth 117 of N3 is “science”.

A semantic vector 23 and a determination result are obtained as the second training data 22 is input to the classifier 110 trained using the first training data group 211. The semantic vector 23 is not a word-based semantic vector but a sentence semantic vector. The semantic vector 23 may be represented by values of a plurality of components 1 to 4. The number of components may be appropriately determined. In an example, the number of components is several hundred. The determination result includes the determination label 116.

Returning to FIG. 6, the comparison unit 122 compares the determination label 116 inferred by inputting each piece of the second training data 22 (#10 to #12 in FIG. 8) and the ground truth 117 of the second training data 22.

In the data #11 illustrated in FIGS. 7 and 8, the determination label 116 is science, the ground truth 117 is society, and the determination label 116 and the ground truth 117 are different. The second training data 22 (#11 in FIG. 8, or the like) in which the determination label 116 and the ground truth 117 are different is referred to as different data 221 (discrepancy group data). The second training data 22 (#10 and #12 in FIG. 8, or the like) in which the determination label 116 and the ground truth 117 are the same are referred to as equivalent data 222. FIG. 9 illustrates examples of the different data 221 and equivalent data 222.

Description will be given taking a case where #7 and #11 are sentences related to virus mutation in FIGS. 7 and 8, as an example. At the time when #7 included in the existing first training data group 211 is registered, the ground truth 117 for the sentence regarding “virus mutation” is “science”. Meanwhile, the ground truth 117 changes from “science” to “society” due to changes in current affairs at the time of the second training data 22 (#11 in FIG. 8). In this case, when the sentence #11 is input to the classifier 110 trained using the first training data group 211, the determination label 116 is inferred as “science”, which is different from the ground truth 117 “society”. The comparison unit 122 selects the second training data 22 in which the ground truth 117 and the determination label 116 are different such as above.

The existing data update unit 123 illustrated in FIG. 6 updates the existing training data group 21. The existing data update unit 123 updates the first training data group 211 to generate the second training data group 212. The existing data update unit 123 includes a similar range determination unit 124 and a removal unit 125.

The similar range determination unit 124 determines a similar range for the different data 221. In FIG. 8, the similar range determination unit 124 determines the similar range for the different data 221 (#11 in FIG. 8, or the like). The similar range determination unit 124 determines the similar range for each different data 221 in a case where there is a plurality of different data 221.

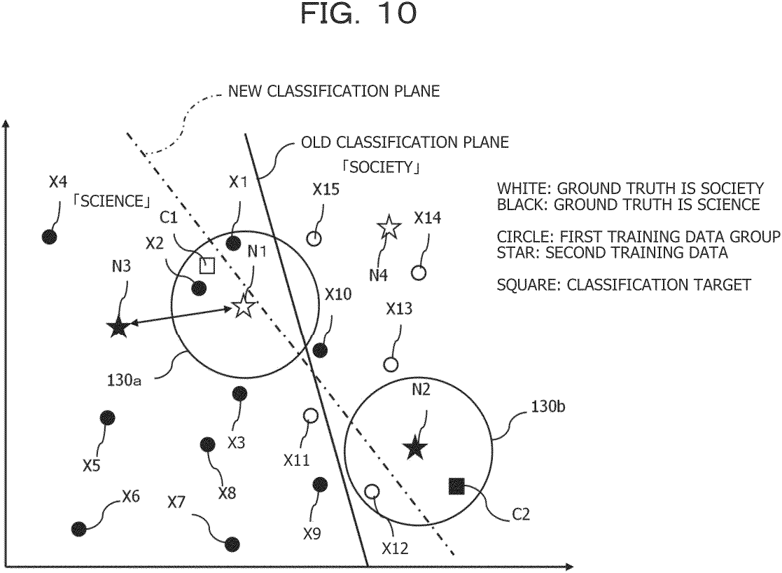

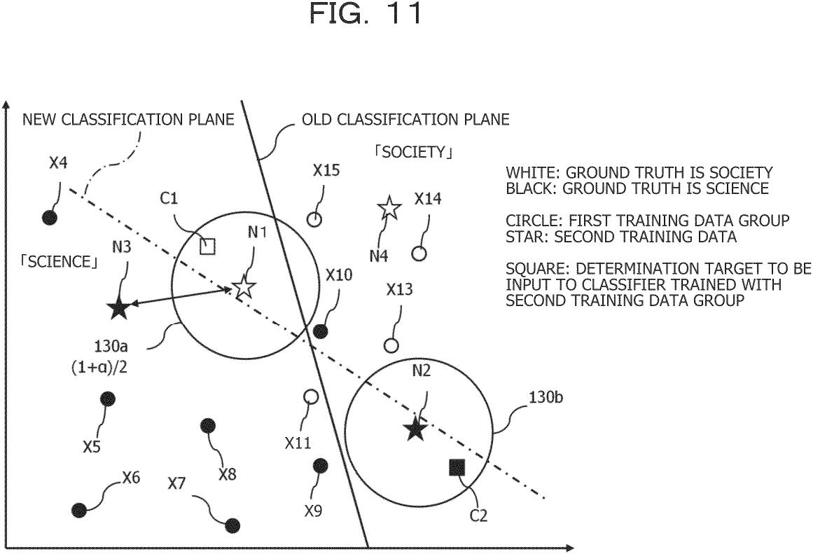

The similar range may be a range on a vector space that satisfies a predetermined relationship with a feature map vector (for example, the semantic vector 23) obtained by vectorizing the different data 221. The similar range will be described with reference to FIGS. 10 and 11.

FIG. 10 is a diagram illustrating an example of classification processing in the comparative example. FIG. 11 is a diagram illustrating an example of classification processing in the first embodiment. FIGS. 10 and 11 illustrate feature map vector spaces of input data. In the case where the input data is the input sentence 111, the feature map vector space is the space of the semantic vectors 23 obtained by vectorizing the input sentence 111.

In FIGS. 10 and 11, a circle indicates the first training data group 211, and a star indicates the second training data 22 that is training data to be newly added. In the first training data group 211 and the second training data 22, the training data in which the ground truth 117 is the first label “society” is illustrated in white, and the training data in which the ground truth 117 is the second label “science” is illustrated in black.

An old classification plane means a boundary plane where the label “society” and the label “science” are distinguished by the classifier 110 trained with the first training data group 211. A new classification plane means a boundary plane where the label “society” and the label “science” are distinguished by the classifier 110 trained with the second training data group 212.

In FIG. 11, the second training data (N1) has the ground truth 117 of “society” and the determination label 116 by the old classification plane of “science”. The second training data (N2) has the ground truth 117 of “science” and the determination label 116 by the old classification plane of “society”. Therefore, each piece of the second training data (N1, N2) is the different data 221. The remaining second training data (N3 and N4) are the equivalent data 222.

The equivalent data 222 most similar to N1 that is the different data 221 is N3. A similar range 130a in N1 that is the different data 221 may be determined to be narrower as the similarity between N1 that is the different data 221 and any data of the plurality of equivalent data 222 (N3 and N4) is higher. The closer the distance in the vector space, the higher the similarity.

The similar range 130a may be determined based on a that is a maximum value of similarities between the different data 221 (N1) and each piece of the plurality of equivalent data 222 (N3 and N4). A similar range 130b may also be determined based on a that is a maximum value of similarities between the different data 221 (N2) and each piece of the plurality of equivalent data 222 (N3 and N4).

In an example, the similar range may be defined for each different data 221 according to 1 - ((1 - a)/2), for example, (1 + a)/2. Furthermore, sizes of the similar ranges 130a and 130b may differ for each piece of the different data 221 (N1 and N2). For example, the similar range 130a for the different data 221 (N1) is a range where the similarity is 0.85 or higher. The similar range 130a for the different data 221 (N2) is a range where the similarity is 0.80 or higher.

In an example, the similarity is cosine similarity. The cosine similarity is a cosine value of an angle made by two vectors and is given by the following equation.

$$\begin{matrix}cos \left(a , b\right) = \frac{a ⋅ b}{\left‖a\right‖ \left‖b\right‖} \\ = \frac{{\sum }_{i = 1}^{n} {a}_{i} {b}_{i}}{\sqrt{{\sum }_{i = 1}^{n} {a}_{i}^{2}} \sqrt{{\sum }_{i = 1}^{n} {b}_{i}^{2}}}\end{matrix}$$

The cosine similarity takes a value of -1 or more and 1 or less. In a case where the cosine similarity is close to 1, the two vectors are close to the same direction. In a case where the cosine similarity is close to -1, the two vectors are close to opposite directions. In a case where the cosine similarity is close to 0, the two vectors are dissimilar. Note that the similarity is not limited to the cosine similarity.

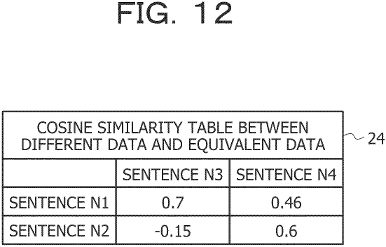

FIG. 12 is a table illustrating an example of a first table 24 illustrating the cosine similarity between the different data 221 (N1 and N2) and the equivalent data 222 (N3 and N4). The maximum value a in the cosine similarity between the different data 221 (N1) and the equivalent data 222 (N3 and N4) is 0.7. Therefore, the similar range 130a for the different data 221(N1) is (1 + 0.7)/2 = 0.85. The maximum value a in the cosine similarity between the different data 221 (N2) and the equivalent data 222 (N3 and N4) is 0.6. Therefore, the similar range 130b for the different data 221(N2) is (1 + 0.6)/2 = 0.8.

Returning to FIG. 6, the removal unit 125 removes, from the first training data in the first training data group 211, at least the first training data included within the similar ranges 130a and 130b.

Note that, in the comparative example illustrated in FIG. 7, N pieces of the first training data are removed from the first training data group 211 in order from the oldest registration time, where the number of newly added pieces of the second training data 22 is N, and the first training data group 211 is updated to the second training data group 212. However, #7 included in the similar range of #11 that is the different data 221 remains. Therefore, #11 and #7 have similar data content but the situation where the ground truth 117 differs between #11 and #7 is not resolved. Since the ground truth 117 is affected by the outdated training data (#7), it may be difficult to suppress a decrease in the classification accuracy.

In the first embodiment illustrated in FIG. 8, the removal unit 125 removes #7 included in the similar range of #11 that is the different data 221. Therefore, the situation where #11 and #7 with different ground truths 117 coexist despite the fact that the semantic vectors 23 are data with similar content is resolved. Therefore, it is possible to reduce an influence of the outdated training data (#7), thereby suppressing a decrease in the classification accuracy.

As illustrated in FIG. 8, the removal unit 125 may further remove (N - S) pieces of data in the first training data group 211 in order from the oldest addition time. In the present example, since N = 3 and S = 1, the oldest two data (N - S), for example, #1 and #2, are removed. Therefore, it is possible to prevent an increase or a decrease in the number of training data more than needed.

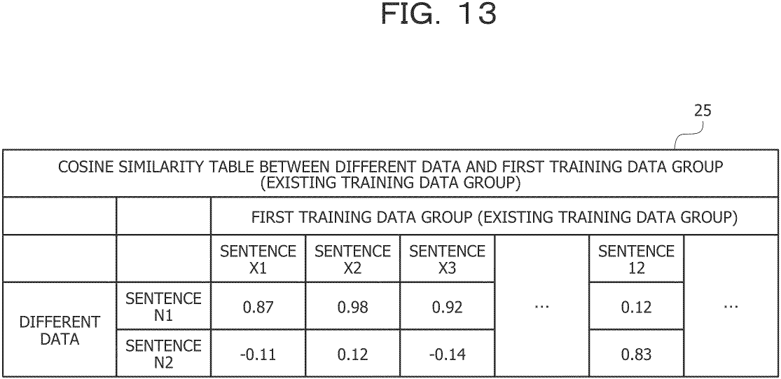

FIG. 13 is a table illustrating an example of a second table 25 illustrating the cosine similarity between the different data 221 (N1 and N2) and the first training data group 211. The removal unit 125 may calculate the cosine similarity between the different data 221 (N1) and all the first training data groups 211. Then, the removal unit 125 removes the first training data (X1 and X2) in which the cosine similarity is within the similar range 130a (for example, 0.85 or more) for the different data 221 (N1). Similarly, the removal unit 125 may calculate the cosine similarity between the different data 221 (N2) and all the first training data groups 211. Then, the removal unit 125 removes the first training data (X12) in which the cosine similarity is within the similar range 130b (for example, 0.8 or more) for the different data 221 (N2).

In the comparative example illustrated in FIG. 10, X1 and X2 of the first training data group 211, which is existing training data, remain within the similar range of different data 221 (N1). Furthermore, X12 of the first training data group 211, which is the existing training data, remains in the similar range of the different data 221 (N2). Therefore, even though the training data has been updated by adding the new second training data 22, the machine learning model of the classifier 110 is affected by the obsolete first training data (X1, X2, and X12).

Therefore, according to the comparative example, even with the new classification plane in the updated classifier 110, there is a possibility that determination target data C1 in which the ground truth 117 is originally “society” is erroneously determined as “science”, or determination target data C2 in which the ground truth 117 is “science” is erroneously determined as “society”.

In the first embodiment illustrated in FIG. 11, X1 and X2 of the first training data group 211, which are within the similar range 130a of the different data 221 (N1), are removed by the removal unit 125. X12 of the first training data group 211 is also removed by the removal unit 125 within the similar range 130b of the different data 221 (N2).

Therefore, according to the information processing device 1 of the first embodiment, it is suppressed that the determination target data C1 in which the ground truth 117 is originally “society” is erroneously determined as “science”, and the determination target data C2 in which the ground truth 117 is “science” is erroneously determined as “society” with the new classification plane in the updated classifier 110.

### [A3] During Retraining

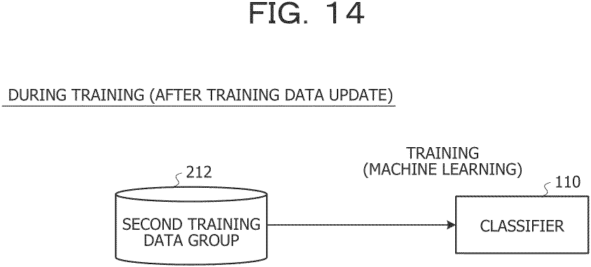

FIG. 14 is a block diagram schematically illustrating a software configuration example during training after updating the existing training data group 21 in the first embodiment. During retraining, the classifier 110 is trained using the second training data group 212 generated by the training processing unit 100. Moreover, new second training data 22 may be added to further update the second training data group 212 that is the existing training data group 21. The update of the second training data group 212 corresponds to the case of setting the second training data group 212 to the pre-update existing training data group 21 (first training data group 211) in FIG. 6 and the like. Therefore, repeated description is omitted.

### [B Operation

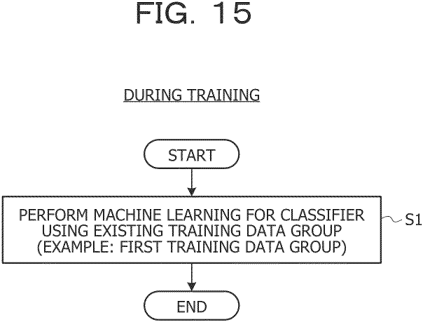

A training method for the machine learning model in the information processing device 1 as an example of the embodiment configured as described above will be described with reference to the flowchart illustrated in FIGS. 15 to 19.

### [B1] During Training

FIG. 15 is a flowchart illustrating processing during training by the information processing device 1 in the first embodiment.

During training, the training processing unit 100 trains the classifier 110 using the existing training data group 21 (operation S1). The existing training data group 21 is the first training data group 211, for example.

### [B2] During Inference (During Generation of the Second Training Data Group 212)

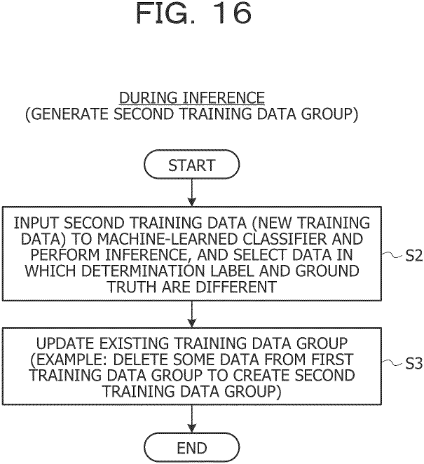

FIG. 16 is a flowchart illustrating training data generation processing of the information processing device in the first embodiment.

The training processing unit 100 selects the different data 221 in which the determination label 116 inferred by inputting the second training data 22 (new supervised data) to the machine-learned classifier 110 and the ground truth 117 of the second training data 22 are different (operation S2).

The training processing unit 100 updates the existing training data group 21 (operation S3). The training processing unit 100 may delete some data from the first training data group 211 to create the second training data group 212.

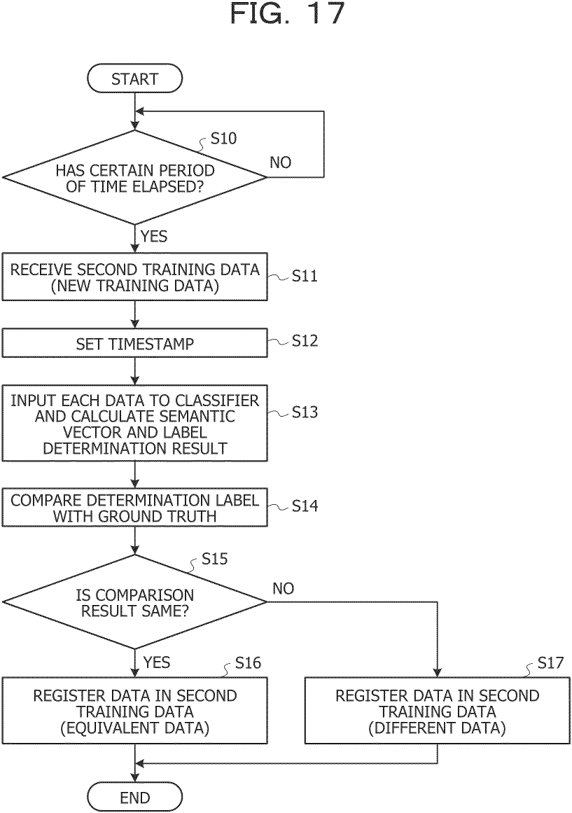

FIG. 17 is a flowchart illustrating selection processing for the second training data 22 by the information processing device 1 in the first embodiment. FIG. 17 illustrates an example of operation S2 in FIG. 16.

After waiting for a certain period of time to elapse (see YES route in operation S10), the processing proceeds to operation S11. Therefore, the processing of operations S11 to S17 may be executed at every certain period of time.

In operation S11, the training processing unit 100 receives the second training data 22 (new supervised data). The second training data 22 may be acquired via the ground-truth-labeled sentence collection unit 20.

In operation S12, the training processing unit 100 may set a timestamp for each piece of training data. The timestamp is information indicating date and time when the training data has been registered.

In operation S13, the training processing unit 100 inputs the second training data 22 to the classifier 110, and calculates the semantic vector 23 and a label determination result as illustrated in FIG. 9. The label determination result includes information regarding the inferred determination label 116.

In operation S14, the comparison unit 122 compares the determination label 116 with the ground truth 117. In a case where the determination label 116 and the ground truth 117 are the same (see YES route in operation S15), the comparison unit 122 registers the second training data 22 in the group of the equivalent data 222 (operation S16). In a case where the determination label 116 and the ground truth 117 are different (see NO route in operation S15), the comparison unit 122 registers the second training data 22 in the group of the different data 221 (operation S17).

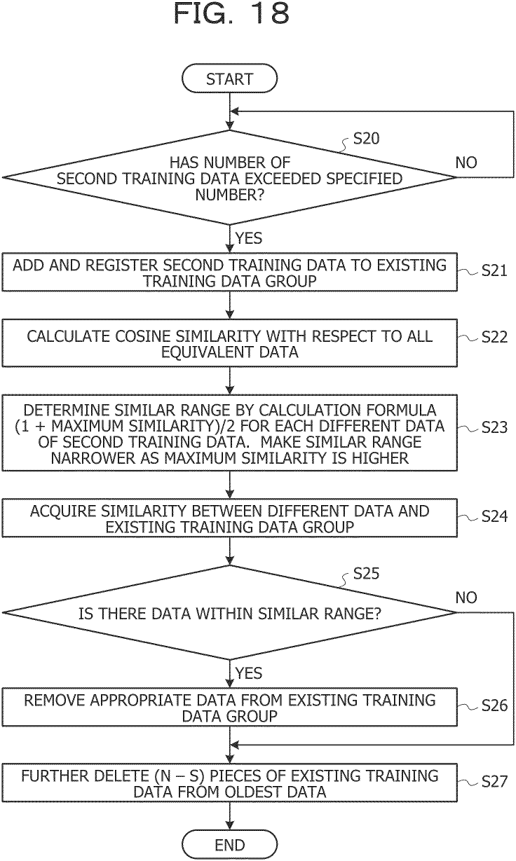

FIG. 18 is a flowchart illustrating update processing for the existing training data by the information processing device 1 in the first embodiment. FIG. 18 illustrates an example of operation S3 in FIG. 16.

The new data adding unit 121 waits until the number of second training data 22 exceeds a specified number (see YES route in operation S20), and additionally registers the second training data 22 in the existing training data group 21 (operation S21). The new data adding unit 121 performs processing of adding the second training data 22 to the first training data group 211.

In operation S22, the similar range determination unit 124 may calculate the cosine similarity between each piece of the different data 221 (for example, N1 and N2 in FIG. 11) and all the equivalent data 222 (for example, N3 and N4 in FIG. 11). The calculation results are illustrated in FIG. 12 in an example.

In operation S23, the similar range determination unit 124 determines the similar range 130 for each piece of the different data 221 (for example, N1 and N2 in FIG. 11) of the second training data 22 using a calculation formula.

In an example, the similar range determination unit 124 calculates the maximum value a in the cosine similarity between each different data 221 and all the equivalent data 222. The similar range determination unit 124 may determine the similar range 130 for each different data 221 by (1 + a)/2. The similar range determination unit 124 may determine the similar range 130 differently according to each piece of the different data 221. The similar range determination unit 124 may determine, for each different data 221, the similar range to be narrower as the similarity between the different data 221 (for example, N1 or N2 in FIG. 11) and any data of the plurality of equivalent data 222 (for example, N3 and N4 in FIG. 11) is higher. As the maximum value a increases (approaches 1), (1 + a)/2 increases (approaches 1). Therefore, the larger the maximum value a, the narrower the similar range 130 in the vector space.

In operation S24, the removal unit 125 acquires the similarity between the different data 221 and the existing training data group 21. The removal unit 125 acquires the similarity between the different data 221 and the existing training data group 21. For example, the removal unit 125 calculates the cosine similarity between different data 221 and each first training data included in the first training data group 211.

In operation S25, the removal unit 125 determines whether there is data included within the similar range 130 among the training data of the existing training data group 21. For example, the removal unit 125 determines whether there is data included within the similar range 130 among the plurality of first training data included in the first training data group 211. In a case where there is data included within the similar range 130 among the training data of the existing training data group 21 (see YES route of operation S25), the removal unit 125 removes the data from the existing training data group 21 (operation S26), in a case where there is no data included within the similar range 130 among the training data of the existing training data group 21 (see NO route of operation S25), the processing proceeds to operation S27.

In operation S27, the removal unit 125 may further remove (N - S) pieces of the plurality of first training data in order from the oldest addition time. N is the number of newly added second training data 22 and S is the number of first training data to be removed as being included within the similar range 130.

### [B3] During Retraining

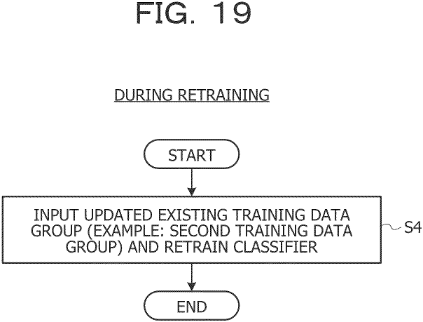

FIG. 19 is a flowchart illustrating processing during retraining by the information processing device 1 in the first embodiment.

During retraining, the training processing unit 100 retrains the classifier 110 using the updated existing training data group 21 (operation S4). The updated existing training data group 21 is, for example, the second training data group 212 obtained by updating the first training data group 211.

The second training data group 212 may be further re-updated by adding the new second training data 22 to the updated second training data group 212. In this case, the second training data group 212 before re-update is set as the first training data group 211 and the training data group after re-update is set as the second training data group 212. Then, the existing training data group 21 may be sequentially updated by applying the methods illustrated in FIGS. 16 to 18.

### Second Embodiment

### [A Configuration

An information processing device 1 of a second embodiment will be described. A hardware configuration of the information processing device 1 of the second embodiment is similar to the hardware configuration of the first embodiment illustrated in FIG. 1. Therefore, repeated description is omitted.

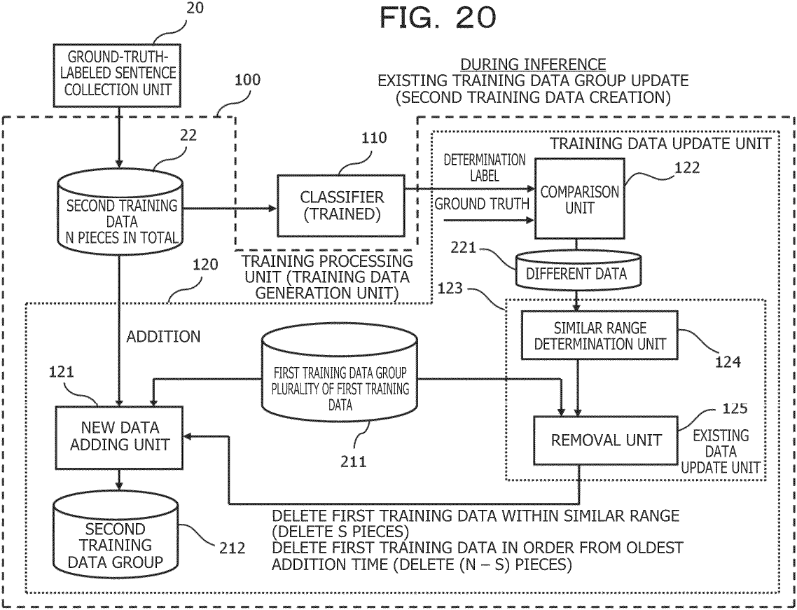

FIG. 20 is a block diagram schematically illustrating a software configuration example during inference in the second embodiment. The second embodiment differs from the first embodiment in the similar range determination method. Processing of the second embodiment does not necessarily need equivalent data 222 to determine the similar range. Other software configurations in the second embodiment are similar to those in the first embodiment. Therefore, repeated description is omitted, and configurations similar to those in the first embodiment are given the same reference numerals.

In the first embodiment, the processing of determining the similar range 130 by the calculation formula is performed for each piece of different data 221 of the second training data 22. For example, the similar range determination unit 124 changes the size of the similar range 130 according to the different data 221. However, in the second embodiment, the size of a similar range 130 may be fixed for each piece of different data 221. The size of the similar range 130 is represented by a distance R (where R is a constant) from each different data 221 in a feature map vector (semantic vector 23) space. The value of R may be predetermined.

### [B Operation

Operations during training and retraining by the information processing device 1 of the second embodiment are similar to those of the information processing device 1 of the first embodiment illustrated in FIGS. 15 and 19. Therefore, detailed description is omitted.

The operation during inference of the information processing device 1 of the second embodiment is common to the operation of the information processing device 1 of the first embodiment illustrated in FIG. 16. Note that the information processing device 1 of the second embodiment does not use equivalent data 222 in processing of determining a similar range 130, and thus the processing of operation S16 in FIG. 17 may be omitted.

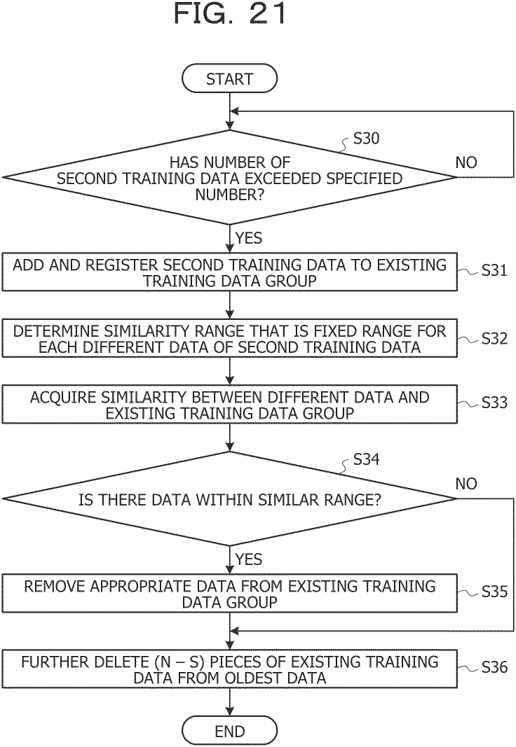

FIG. 21 is a flowchart illustrating update processing for existing training data by the information processing device 1 in the second embodiment. In processing illustrated in FIG. 21, the processing of operations S30, S31, and S33 to S36 is similar to the processing of operations S20, S21, and S24 to S27 illustrated in FIG. 18. Therefore, detailed description is omitted.

In operation S32, a similar range determination unit 124 determines a similar range 130, which is a fixed range for each piece of different data 221 in second training data 22.

According to the information processing device 1 of the second embodiment, calculation using the equivalent data 222 is not needed for determining the similar range 130. Therefore, obsolete data can be deleted with a simplified configuration.

### Third Embodiment

### [A Configuration

An information processing device 1 of a third embodiment will be described. A hardware configuration of the information processing device 1 of the third embodiment is similar to the hardware configuration of the first embodiment illustrated in FIG. 1. Therefore, repeated description is omitted.

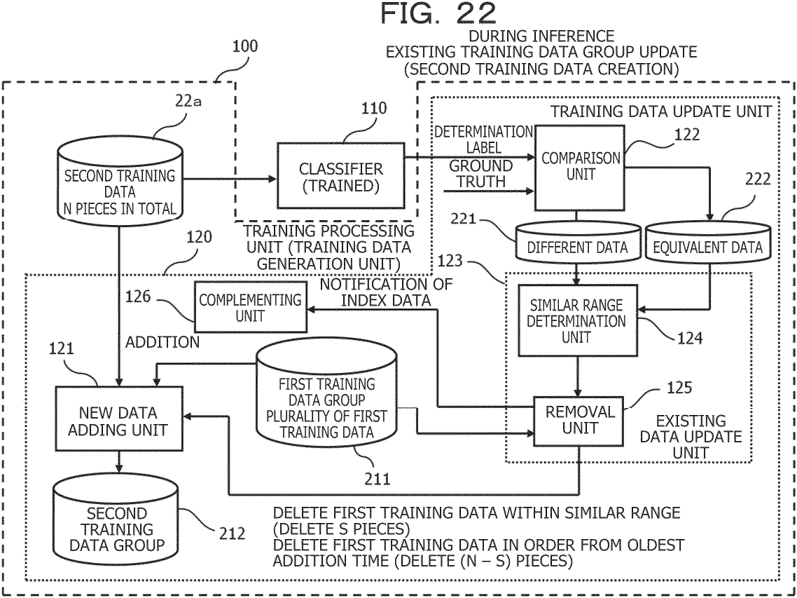

FIG. 22 is a block diagram schematically illustrating a software configuration example during inference in the third embodiment. The information processing device 1 of the third embodiment has a complementing unit 126 added to the software configuration of the first embodiment illustrated in FIG. 6 or the software configuration of the second embodiment illustrated in FIG. 20. FIG. 22 illustrates a configuration in which the complementing unit 126 is added to the software configuration of the information processing device 1 of the first embodiment. However, the complementing unit 126 may be added to the software configuration of the information processing device 1 of the second embodiment.

A removal unit 125 notifies the complementing unit 126 of index data.

Second training data 22a may be generated through processing by a training processing unit 100 instead of being obtained from a ground-truth-labeled sentence collection unit 20 as in FIGS. 6 and 20.

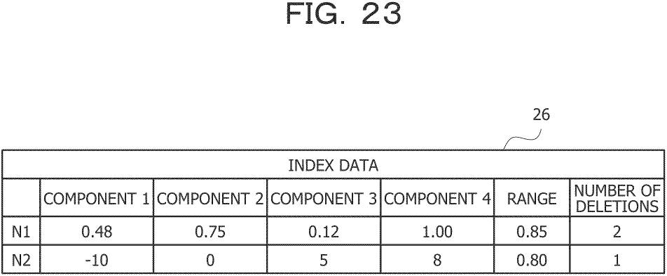

FIG. 23 illustrates an example of index data 26. The index data 26 is data that serves as an index for collecting the new second training data 22a. The index data 26 is generated based on a similar range 130 from which first training data included in an existing training data group 21 (first training data group 211) has been removed or the removed first training data. For example, the index data 26 is generated based on a position in a vector space of the similar range 130 from which first training data included in an existing training data group 21 (first training data group 211) has been removed or a position in the vector space of the removed first training data.

In an example, the index data 26 includes components of second training data 22 (N1 in FIG. 11) corresponding to a similar range 130a from which the first training data (X1 and X2 in FIG. 11) have been removed. The index data 26 may include information (0.85 in FIG. 11) about an index range (corresponding to the similar range 130a) corresponding to the second training data 22 (N1 in FIG. 11). Moreover, the index data 26 may include information about the number of first training data removed as being included in the similar range 130a (the number of first training data deleted as being included in the similar range 130a is 2).

The index data 26 is generated for each of a plurality of similar ranges 130 (in the case of FIG. 11, similar ranges 130a and 130b) in the case where the first training data is removed as being included in the similar range 130. The index data 26 for the similar range 130b corresponding to the second training data 22 (N2 in FIG. 11) includes components of the second training data 22 (N2 in FIG. 11), information (0.8) of the similar range 130b, and the number (one) of the first training data (X12 in FIG. 11).

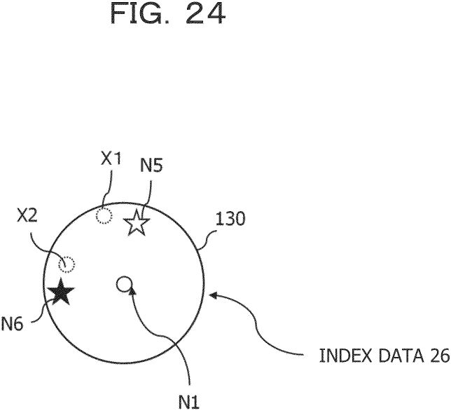

FIG. 24 is a diagram illustrating an example of data selection processing based on the index data 26. The index data 26 correspond to a region from which the first training data has been removed. The region from which the first region data has been removed becomes a region with sparse training data in the vector space. Therefore, by preferentially collecting new training data based on the index data 26, it is possible to preferentially replenish the training data for the sparse region. The index data 26 is not limited to the cases illustrated in FIGS. 23 and 24.

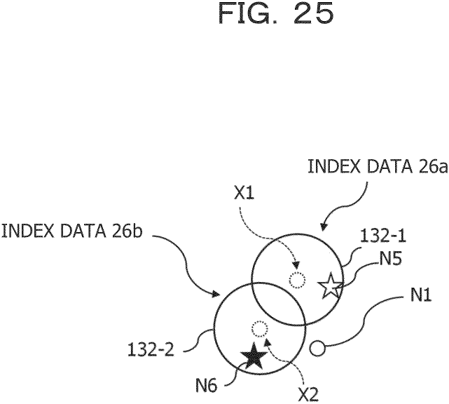

FIG. 25 is a diagram illustrating another example of the data selection processing based on index data 26a and 26b. As illustrated in FIG. 25, index data 26a, 26b may be respectively generated based on X1 and X2 that are the first training data removed as being included in the similar range 130a. The index data 26a and 26c may include respective components of X1 and X2 that are the first training data and index ranges 132-1 and 132-2 in the respective pieces of removed first training data (X1 and X2).

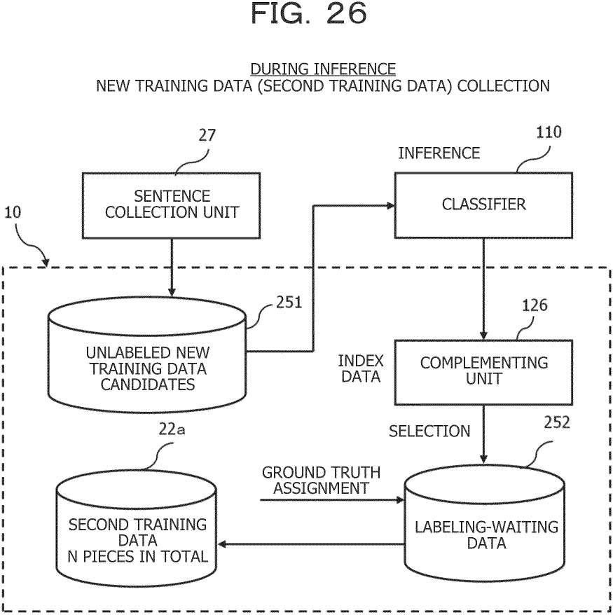

FIG. 26 is a block diagram schematically illustrating a software configuration example during creation of new second training data 22 in the third embodiment. FIG. 26 illustrates processing of collecting new second training data 22a based on the index data 26.

Unlike the first and second embodiments, a sentence collection unit 27 may acquire unlabeled new training data candidates 251 to which a ground truth 117 is not added. The unlabeled new training data candidate 251 may be a target data candidate before the ground truth 117 is added in supervised data.

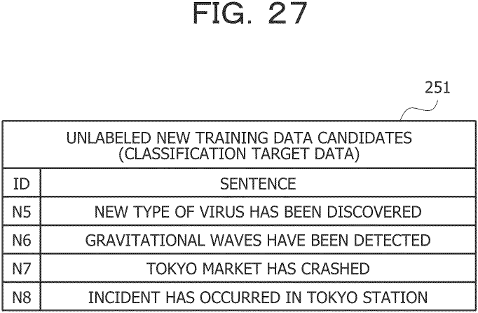

FIG. 27 is a table illustrating an example of the unlabeled new training data candidates 251. The unlabeled new training data candidates 251 may include identification information and sentences (target data portions).

The unlabeled new training data candidate 251 is input to a classifier 110. The classifier 110 infers and outputs a feature map vector (semantic vector 23) corresponding to the unlabeled new training data candidate 251.

The complementing unit 126 selects labeling-waiting data 252 from the unlabeled new training data candidates 251 based on the feature map vector (semantic vector 23) inferred by the classifier 110 and the index data 26. The labeling-waiting data 252 is target data to which the ground truth 117 is attached.

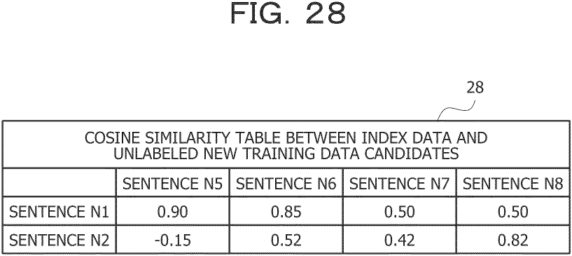

FIG. 28 illustrates a third table 28 including cosine similarity between the index data 26 (corresponding to N1 and N2 in FIG. 11 in an example) and the unlabeled new training data candidates 251. The complementing unit 126 calculates, for each index data 26, the cosine similarity between each index data 26 and each of the unlabeled new training data candidates 251. For example, the complementing unit 126 calculates the cosine similarity between the index data 26 (N1) and each of the unlabeled new training data candidates 251 (N5 to N8). Similarly, the complementing unit 126 calculates the cosine similarity between the index data 26 (N2) and each of the unlabeled new training data candidates 251 (N5 to N8).

The complementing unit 126 refers to an index range 132 (corresponding to the similar range 130 in an example) included in the index data 26. The index range 132 may be defined by, for example, a threshold for the cosine similarity. For example, for the index data 26 (N1), the index range 132 is equal to or greater than 0.85, and for index data 26 (N2), the index range is equal to or greater than 0.8.

The complementing unit 126 selects the labeling-waiting data 252 included in the index range 132 from the third table 28 illustrated in FIG. 28. In the case illustrated in FIG. 28, the complementing unit 126 selects N5 and N6 as the labeling-waiting data 252 included in the index range 132 of the index data 26 (N1). Similarly, the complementing unit 126 selects N8 as the labeling-waiting data 252 included in the index range 132 of the index data 26 (N2). The labeling-waiting data 252 is registered.

As illustrated in FIG. 24, the complementing unit 126 may select the labeling-waiting data 252 existing within the index range (corresponding to the similar range 130) of the index data 26. Alternatively, as illustrated in FIG. 25, the complementing unit 126 may select the labeling-waiting data 252 existing within index ranges 132-1 and 132-2 included in the index data 26a and 26b.

The ground truth 117 is added to the labeling-waiting data 252 to generate the second training data 22a. The ground truth 117 is added to data registered as the labeling-waiting data 252. The addition of the ground truth 117 may be performed by an operator, in an example.

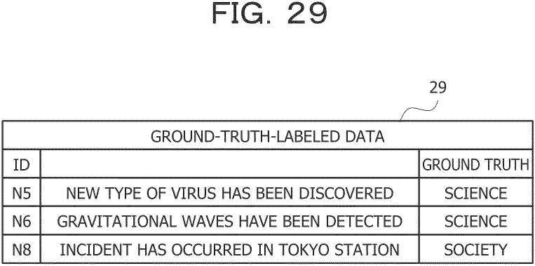

FIG. 29 is a table illustrating an example of ground-truth-labeled data 29. In FIG. 29, the ground truth 117 is added to each of N5 and N6 selected as the labeling-waiting data 252 as being included in the index range of the index data 26 (N1). Similarly, the ground truth 117 is added to N8 selected as the labeling-waiting data 252 included in the index range of the index data 26 (N2). The ground-truth-labeled data 29 is used as the second training data 22a in FIG. 26.

### [B Operation

Operations during training and retraining by the information processing device 1 of the third embodiment are similar to those of the information processing device 1 of the first embodiment illustrated in FIGS. 15 and 19. Therefore, detailed description is omitted.

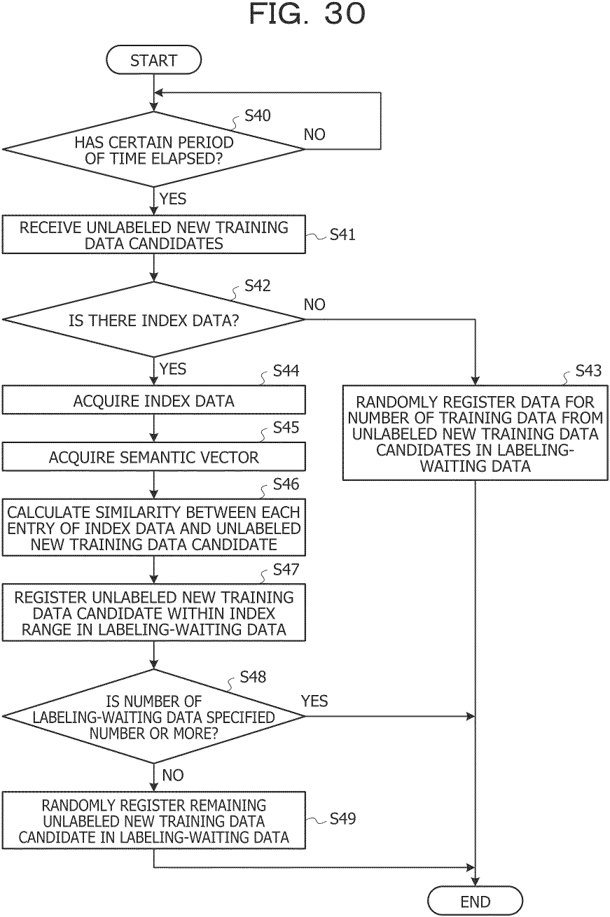

FIG. 30 is a diagram illustrating an example of selection processing for the labeling-waiting data 252 in the third embodiment.

After waiting for a certain period of time to elapse (see YES route in operation S40), the processing proceeds to operation S41. Therefore, the processing of operations S41 to S49 may be executed at every certain period of time.

In operation S41, the training processing unit 100 receives the unlabeled new training data candidates 251 (classification target data). The unlabeled new training data candidates 251 may be obtained from the sentence collection unit 27.

In operation S42, the complementing unit 126 determines whether there is the index data 26. In a case where there is no index data 26 (see NO route in operation S42), the processing proceeds to operation S43. In a case where there is index data 26 (see YES route of operation S42), the processing proceeds to operation S44.

In operation S43, the complementing unit 126 randomly selects data for the required number of second training data from the unlabeled new training data candidates 251. The complementing unit 126 registers the selected unlabeled new training data candidate 251 as the labeling-waiting data 252.

In operation S44, the complementing unit 126 acquires information of the index data 26. The index data 26 may include information such as the components of the corresponding second training data 22, the index range, and the number of deleted first training data, as illustrated in FIG. 23.

In operation S45, the training processing unit 100 inputs the unlabeled new training data candidate 251 to the classifier 110 and acquires the feature map vector (semantic vector 23).

In operation S46, the complementing unit 126 calculates the similarity between each piece of the index data 26 and the unlabeled new training data candidate 251.

In operation S47, the complementing unit 126 selects and registers the unlabeled new training data candidates 251 within the index range corresponding to the similar range 130 or the like as the labeling-waiting data 252.

In a case where the number of registered labeling-waiting data 252 is a specified number or more (see YES route of operation S48), the processing is completed. In a case where the number of registered labeling-waiting data 252 is not the specified number or more (see NO route in operation S48), the processing proceeds to operation S49.

In operation S49, the complementing unit 126 randomly selects and registers the required number of labeling-waiting data from the remaining unlabeled new training data candidates 251.

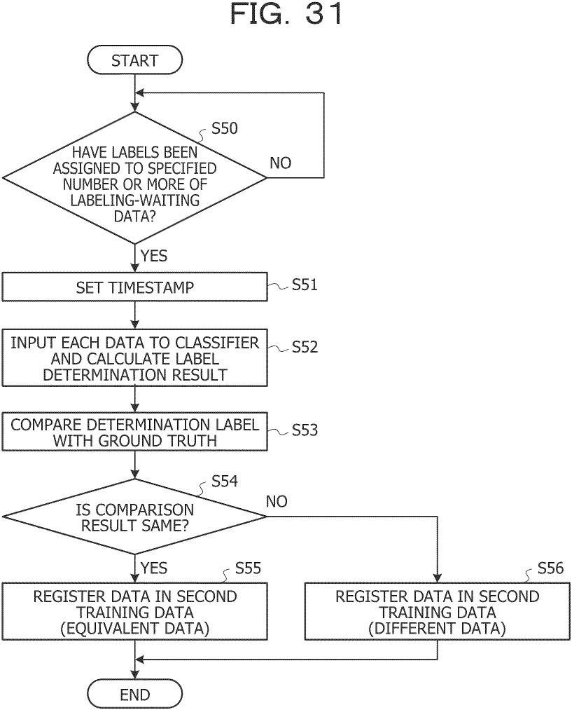

FIG. 31 is a flowchart illustrating selection processing for the second training data 22a by the information processing device 1 in the third embodiment. FIG. 31 illustrates an example of operation S2 in FIG. 16.

The ground truth 117 is added to the labeling-waiting data 252 to generate the new second training data 22a. The ground truth 117 may be added by the operator according to content of a sentence.

In a case where the labels are assigned to a specified number or more of labeling-waiting data (see YES route in operation S50), the processing proceeds to operation S51 and subsequent operations.

In operation S51, the training processing unit 100 may set a timestamp for each training data. The timestamp is information indicating date and time when the training data has been registered.

In operation S52, the training processing unit 100 inputs the second training data 22a to the classifier 110, and calculates the label determination result as illustrated in FIG. 9. The label determination result includes the information regarding inferred determination label 116.

Processing of operations S53 to S56 is similar to the processing of operations S14 to S17 in FIG. 17. Therefore, repeated description is omitted.

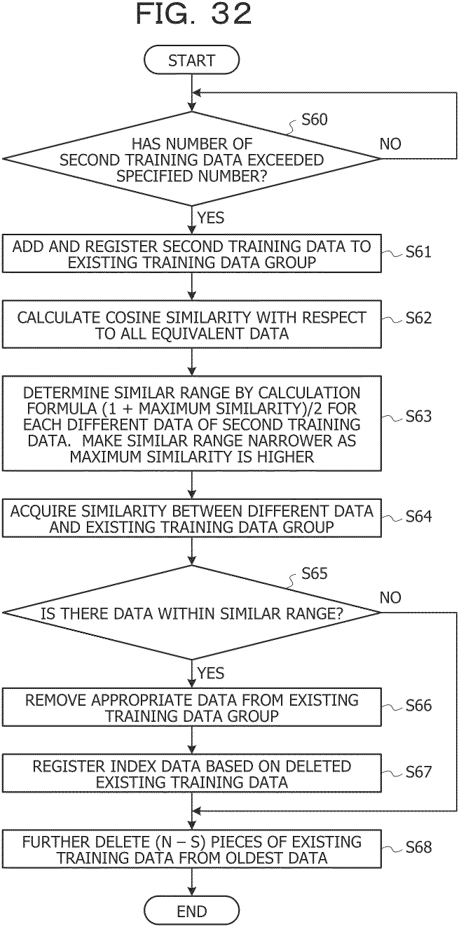

FIG. 32 is a flowchart illustrating an example of update processing for the existing training data by the information processing device 1 in the third embodiment.

The processing of FIG. 32 is similar to the processing of FIG. 18 except that operation S67 is added. For example, processing of operations S60 to S66 and S68 of FIG. 32 is common to the processing of operations S20 to S27 of FIG. 18. Therefore, repeated description is omitted.

In operation S67, the removal unit 125 generates the index data 26 based on the similar range 130 from which the first training data included in the existing training data group 21 (first training data group 211) has been removed or the removed first training data.

A region from which the first region data has been removed becomes a region with sparse training data in a vector space. Therefore, by preferentially collecting new training data based on the index data 26, it is possible to preferentially replenish the training data for the sparse region.

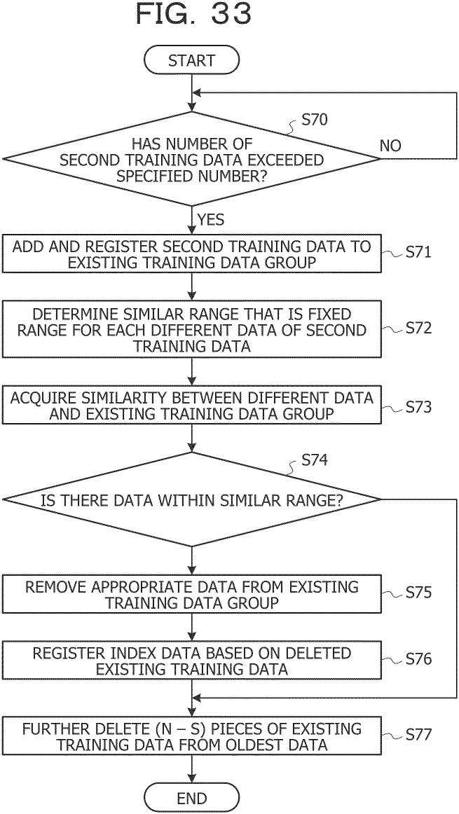

FIG. 33 is a flowchart illustrating another example of the update processing for existing training data by the information processing device 1 in the third embodiment.

The processing of FIG. 33 is similar to the processing of FIG. 21 except that operation S76 is added. For example, processing of operations S70 to S75 and S77 of FIG. 33 is common to the processing of operations S30 to S36 of FIG. 21. Therefore, repeated description is omitted.

In operation S76, the removal unit 125 generates the index data 26 based on the similar range 130 from which the first training data included in the existing training data group 21 (first training data group 211) has been removed or the removed first training data.

### [C] Effects of Embodiments

Thus, in the methods according to the first to third embodiments, the computer uses the determination label 116 inferred by inputting the second training data 22 to the classifier 110 machine-learned using the first training data group 211 including the plurality of first training data. The computer executes the processing of determining the similar range 130 for the second training data 22 in the case where the determination label 116 and the ground truth 117 of the second training data 22 are different. Then, the computer executes the processing of removing at least the first training data included in the similar range 130 from among the plurality of first training data to create the second training data group 212. Then, the computer executes the processing of newly performing machine learning for the classifier 110 using the second training data group 212.

According to the above method, it is possible to suppress a decrease in the data classification accuracy due to obsolescence of training data. Resolved is the situation where the ground truths 117 are different despite the fact that the feature map vectors such as the semantic vectors 23 are data with similar content. Therefore, it is possible to reduce the influence of the first training data with the outdated ground truth 117, thereby suppressing the decrease in the classification accuracy.

The second training data group 212 further includes the second training data 22. Therefore, even in the case where the second training data 22 is added, resolved is the situation where pieces of data with the different ground truths 117 coexists despite the fact that existing first training data group 211 and the second training data 22 are similar data. Therefore, it is possible to reduce the influence of the first training data with the outdated ground truth 117, thereby suppressing the decrease in the classification accuracy.

The processing of determining the similar range 130 determines the range indicating the similarity equal to or greater than a predetermined value with respect to the feature map vector obtained by vectorizing the second training data 22 as the similar range 130 for the second training data 22. Therefore, it is possible to resolve the situation where pieces of data with the different ground truths 117 coexist despite the fact that the feature map vectors such as the semantic vectors 23 are data with similar content.

The second training data 22 includes a plurality of the different data 221 in which the determination label 116 and the ground truth 117 are different, and a plurality of the equivalent data 222 in which the determination label 116 and the ground truth 117 are the same. The similar range 130 is determined to be narrower as the similarity between any data of the plurality of equivalent data 222 and the different data 221 is higher. The similar range 130 is determined for each different data 221.

Therefore, it is possible to remove the first training data within an optimal range for each different data 221.

In the different data 221, the similar range 130 is determined for each different data 221 according to (1 + a)/2, where the maximum value of the similarity between each of the plurality of equivalent data 222 and the different data 221 is α.

Therefore, it is possible to quantitatively remove the first training data within an optimal range for each different data 221.

(N - S) pieces of the plurality of first training data are further removed in order from the oldest addition time in the case where the number of second training data 22 is N and the number of first training data to be removed as being included in the similar range 130 is S.

Therefore, it is possible to suppress obsolescence of training data.

The index data 26 to serve as an index for collecting the new second training data is generated based on the different data 221 that is the second training data 22 which corresponds to the similar range 130 from which the first training data has been removed and in which the determination label 116 and the ground truth 117 are different, or the removed first training data. Then, the new second training data 22 is collected based on the similarity with respect to the index data 26.

Therefore, it is possible to preferentially replenish the training data to the region where the training data is sparse due to the removal of the first region data. Therefore, it is possible to prevent a decrease in the classification accuracy due to sparse training data.

### [D] Others

The disclosed technique is not limited to the embodiment described above, and various modifications may be made without departing from the gist of the present embodiment. For example, each configuration and each processing of the present embodiment may be selected or omitted as needed or may be appropriately combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process, the process comprising:
determining a similar range for second training data in a case where a determination label inferred by inputting the second training data to a classifier machine-learned by using a first training data group that includes a plurality of first training data, and a ground truth of the second training data are different;
creating a second training data group by removing at least the first training data included in the similar range from the plurality of first training data; and
newly performing machine learning of the classifier using the second training data group.

2. The non-transitory computer-readable recording medium according to claim 1, wherein the second training data group includes the second training data.

3. The non-transitory computer-readable recording medium according to claim 1, wherein the determining the similar range determines a range that indicates similarity equal to or greater than a predetermined value with respect to a feature map vector obtained by vectorizing the second training data as the similar range with respect to the second training data.

4. The non-transitory computer-readable recording medium according to claim 1,
wherein the second training data includes a plurality of different data in each of which the determination label and the ground truth are different, and a plurality of equivalent data in each of which the determination label and the ground truth are same, and
the determining the similar range determines the similar range for each of the plurality of different data such that the similar range becomes narrower as similarity between any data of the plurality of equivalent data and the plurality of different data is higher.

5. The non-transitory computer-readable recording medium according to claim 4, wherein the similar range is determined, based on a maximum value of the similarity between the different data and each of the plurality of equivalent data.

6. The non-transitory computer-readable recording medium according to claim 2, wherein the removing at least the first training data included in the similar range, in a case where a number of the second training data is N and a number of the first training data to be removed as being included in the similar range is S, further removes (N - S) of the plurality of first training data in order from the first training data added at older time.

7. The non-transitory computer-readable recording medium according to claim 1, the process further comprising:
generating index data that serves as an index to newly collect the second training data, based on the second training data which corresponds to the similar range from which the first training data has been removed and in which the determination label and the ground truth are different, or the removed first training data; and
newly collecting the second training data based on similarity with respect to the index data.

8. A machine learning method for causing a computer to execute a process, the process comprising:
determining a similar range for second training data in a case where a determination label inferred by inputting the second training data to a classifier machine-learned by using a first training data group that includes a plurality of first training data, and a ground truth of the second training data are different;
creating a second training data group by removing at least the first training data included in the similar range from the plurality of first training data; and
newly performing machine learning of the classifier using the second training data group.

9. The machine learning method according to claim 8, wherein the second training data group includes the second training data.

10. The machine learning method according to claim 8, wherein the determining the similar range determines a range that indicates similarity equal to or greater than a predetermined value with respect to a feature map vector obtained by vectorizing the second training data as the similar range with respect to the second training data.

11. The machine learning method according to claim 8,
wherein the second training data includes a plurality of different data in each of which the determination label and the ground truth are different, and a plurality of equivalent data in each of which the determination label and the ground truth are same, and
the determining the similar range determines the similar range for each of the plurality of different data such that the similar range becomes narrower as similarity between any data of the plurality of equivalent data and the plurality of different data is higher.

12. The machine learning method according to claim 11, wherein the similar range is determined, based on a maximum value of the similarity between the different data and each of the plurality of equivalent data.

13. The machine learning method according to claim 9, wherein the removing at least the first training data included in the similar range, in a case where a number of the second training data is N and a number of the first training data to be removed as being included in the similar range is S, further removes (N - S) of the plurality of first training data in order from the first training data added at older time.

14. The machine learning method according to claim 8, the process further comprising:
generating index data that serves as an index to newly collect the second training data, based on the second training data which corresponds to the similar range from which the first training data has been removed and in which the determination label and the ground truth are different, or the removed first training data; and
newly collecting the second training data based on similarity with respect to the index data.

15. An information processing device comprising:
a memory; and
a processor coupled to the memory and configured to:
determine a similar range for second training data in a case where a determination label inferred by inputting the second training data to a classifier machine-learned by using a first training data group that includes a plurality of first training data, and a ground truth of the second training data are different;
create a second training data group by removing at least the first training data included in the similar range from the plurality of first training data; and
newly perform machine learning of the classifier using the second training data group.

16. The information processing device according to claim 15, wherein the second training data group includes the second training data.

17. The information processing device according to claim 15, wherein the processor is configured to determine a range that indicates similarity equal to or greater than a predetermined value with respect to a feature map vector obtained by vectorizing the second training data as the similar range with respect to the second training data.

18. The information processing device according to claim 15,
wherein the second training data includes a plurality of different data in each of which the determination label and the ground truth are different, and a plurality of equivalent data in each of which the determination label and the ground truth are same, and
the processor is configured to determine the similar range for each of the plurality of different data such that the similar range becomes narrower as similarity between any data of the plurality of equivalent data and the plurality of different data is higher.

19. The information processing device according to claim 18, wherein the similar range is determined, based on a maximum value of the similarity between the different data and each of the plurality of equivalent data.

20. The information processing device according to claim 16, wherein the processor is configured to, in a case where a number of the second training data is N and a number of the first training data to be removed as being included in the similar range is S, further remove (N - S) of the plurality of first training data in order from the first training data added at older time.
